(19) United States
(12) Patent Application Publication
(10) Pub. No.: US 2025/0033636 A1
(43) Pub. Date: Jan. 30, 2025

(54) Method and Device for the Automated Longitudinal Guidance of a Motor Vehicle

(71) Applicant: Bayerische Motoren Werke Aktiengesellschaft, Muenchen (DE)

(72) Inventors: Miguel LOENNE, Muenchen (DE); Helena DOLINAJ, Muenchen (DE); Sebastien MATHIEU, Fuerstenfeldbruck (DE); Julius SCHULZ, Muenchen (DE)

(21) Appl. No.: 18/707,149

(22) PCT Filed: Sep. 22, 2022
(86) PCT No.: PCT/EP2022/076412

§ 371 Date: May 2, 2024

(30) Foreign Application Priority Data
Nov. 3, 2021 (DE) 10 2021 128 539.9

(51) Int. Cl. B60W 30/14; B60W 30/045; B60W 30/18; B60W 50/00; B60W 60/00

(52) U.S. Cl. CPC B60W 30/143; B60W 30/045; B60W 30/18154; B60W 50/0097; B60W 60/001; B60W 2520/10; B60W 2556/40

(57) ABSTRACT

A method for the automated longitudinal guidance of a motor vehicle includes detecting whether there are two turns in a section lying ahead on a route. If so, the speed of the motor vehicle is maintained at a constant target speed value after having passed through a first of the two turns until reaching a second of the two turns.

### CROSS REFERENCE TO RELATED APPLICATION

This application is a 371 of International Application No. PCT/EP2022/076412, filed Sep. 22, 2022 which claims priority under 35 U.S.C. § 119 from German Patent Application No. 10 2021 128 539.9, filed Nov. 3, 2021, the entire disclosure of which is herein expressly incorporated by reference.

### BACKGROUND AND SUMMARY

The invention relates to a method for the automated longitudinal guidance of a motor vehicle, in particular when cornering. The present invention furthermore relates to a control device which is configured to at least partially execute the method as well as a computer program and a computer-readable storage medium, in each case comprising commands which, when executing the program or the commands by a computer, cause it to at least partially execute the method.

Devices and methods are generally known from the prior art which can influence a transverse and/or longitudinal guidance of a motor vehicle in an automated manner and can control or steer the motor vehicle by influencing the transverse and/or longitudinal guidance in an automated manner through a curve.

For example, a driver assistance system for a vehicle is known from DE 10 2019 128 910 A1. The driver assistance system comprises a detection unit which is configured to detect an upcoming exit maneuver from a carriageway involving cornering and a control unit which is configured to determine a point in time and/or a position for a start of a coasting of the vehicle on the basis of at least one route parameter and at least one vehicle parameter so that a speed of the vehicle at the start of the cornering is equal to a first threshold value and at the end of the cornering is equal to a second threshold value, wherein the first threshold value is greater than the second threshold value.

Such a conventional proactive control regulation technology for turns or curves typically has, however, base dynamics according to which the motor vehicle accelerates after passing an event, i.e. after passing the curve. This means that the motor vehicle accelerates (positively) after passing through the curve initially irrespectively of the further route profile and then brakes, where necessary, again in the case of a subsequent curve in the route profile.

These acceleration characteristics may be felt to be overly dynamic and unreliable on a route section or a route profile with several turns which follow closely on from one another, as is the case, for example, with a U-turn. This suggests to the driver or user of the motor vehicle that this situation cannot be properly mastered by the driver assistance system.

The acceleration between the several turns which follow on closely from one another furthermore leads to increased energy consumption which, depending on the drive type of the motor vehicle, results in increased fuel consumption and a decreasing range.

Against the background of this prior art, the object of the present invention lies in indicating a device and a method which are in each case suited to overcoming at least the above-mentioned disadvantages of the prior art.

The object is achieved by the features of the independent claim. The subordinate claims contain preferred further developments of the invention.

Accordingly, the object is achieved by a method for the automated longitudinal guidance of a motor vehicle.

The method is characterized in that it comprises detecting whether two turns lie or exist in an upcoming route section.

The method is furthermore characterized in that it comprises maintaining a speed of the motor vehicle at a constant target speed value after passing through a first of the two turns until a second of the two turns is reached if it is detected that two turns lie in the upcoming route section.

In other words, a method for controlling and/or regulating a speed of an automated motor vehicle is provided. For this purpose, it is initially checked whether the motor vehicle has to pass two consecutive curves or turns within an upcoming route section. The route section can have a static or ever constant length or a length which changes, e.g. as a function of a speed of the motor vehicle. If two turns are detected, the speed of the motor vehicle is adjusted so that an increase in the speed of the motor vehicle between the two curves, as is the case with conventional methods, is avoided. This means that ideally no intervention in the longitudinal dynamics of the motor vehicle is necessary when passing through the two turns. As a result of this, the acceleration described above and subsequent braking between the two turns can be avoided. This is firstly advantageous for an energy consumption of the motor vehicle, i.e. as a result of the proactive mode of driving, unnecessary energy consumption due to acceleration and braking is avoided. This is, however, also advantageous in terms of the confidence of the user or driver of the motor vehicle in the automated driving of the motor vehicle since the acceleration and braking described above are avoided. The disadvantages described above of the prior art can therefore be overcome with the method.

Preferred further developments of the method described above are discussed in detail below.

The detection as to whether two turns lie in the upcoming route section can comprise adding up an angle of the first turn and an angle of the second turn in order to obtain a total angle. The total angle can be compared with a threshold value. If the total angle exceeds the threshold value, it can be detected that two turns lie in the upcoming route section.

In other words, it can thus be detected by means of the method whether two turns are present in the first place and the method then adjusts the constant target speed value described above, the angles of the upcoming turns are firstly determined and these are then added up. The respective turn can then be identified substantially as a circular arc. The angle of the turn can then correspond to the center point angle of the circular arc. It is also conceivable, additionally or alternatively, that the (at least) two turns are part of a roundabout. A turn is, however, not limited to a circular arc or a circular road layout. It is also conceivable, additionally or alternatively, that at least one of the two turns occurs as part of an intersection, i.e. for example, when turning right or left at an intersection in the case of which the road layout has a bend which encloses, for example, substantially an inner angle of 90°. The turns detected in this manner and in particular their center point angles or inner angles are subsequently added up. The sum of the two angles is subsequently compared with a threshold value. The threshold value can be a fixed or static threshold value. It is, however, also conceivable that the threshold value changes dynamically, for example, as a function of a current speed of the motor vehicle.

It is conceivable that the constant target speed value is selected as a function of the total angle.

In particular, the constant target speed value can reduce with increasing value of the total angle, i.e. if two sharp curves follow one another, the constant target speed value can be lower than in the case of two less sharp curves.

The method can comprise adjusting the speed of the motor vehicle to the constant target speed value before the motor vehicle reaches the first turn if it is detected that two turns lie in the upcoming route section.

In other words, the method can adjust the speed of the motor vehicle at an early stage by an intervention in the longitudinal guidance of the motor vehicle or regulate and/or control it to the constant target speed value so that the vehicle is driving at the constant target speed value even before reaching the first of the two turns. Braking in the curve can thus be prevented. This is advantageous because the friction force of the tires on the ground must deliver the required centripetal force during each steering maneuver. This lateral guidance force transverse to the rolling direction prevents the vehicle from leaving the carriageway in a curve. When braking in the longitudinal direction, the tire must additionally transmit the longitudinal force in the longitudinal direction. These two forces are added together vectorially to form a resulting total force which can become greater the more grip the carriageway and tires have. In the case of wet conditions and icy conditions, however, only relatively small forces can be transmitted. This means that, by adjusting the speed of the motor vehicle to the constant target speed value before reaching the first curve, not only can the confidence of the user of the motor vehicle in the automated driving be increased, but also a relatively safe passing through the curve can be enabled.

The method can comprise adjusting the speed of the motor vehicle to a target speed value which exceeds the constant target speed value during or after passing through the second turn if it is detected that two turns lie in the upcoming route section.

This means that the method can provide a (positive) acceleration of the motor vehicle once the second curve is reached. It is in particular conceivable that acceleration is performed from an apex of the second turn.

The detection as to whether two turns lie in an upcoming route section can be performed on the basis of map data and a planned trajectory of the motor vehicle.

It is conceivable that, for example, map data of a navigation device installed in the motor vehicle are used which have information about the road layout of the upcoming route section. The trajectory can furthermore comprise information as to which part of the upcoming route section will be passed by the motor vehicle, i.e. which route the motor vehicle will select. The trajectory can furthermore also be referred to as a path. The path can, in the manner described above, have bends and/or circular arcs which are necessary in order to be able to pass through turns. These bends and circular arcs can be determined and their inner angle or center point angle can be called on to determine whether a turn is present. This may be the case if the respective angle of the circular arc or the bend exceeds a further predetermined threshold value. This threshold value can also be a fixed or static threshold value. It is, however, also conceivable that this threshold value changes dynamically, for example, as a function of the current speed of the motor vehicle.

The situation described above can be summarized in other words and in relation to a concrete configuration as follows.

As a result of the method described above, an improved interpretation of an upcoming road geometry of turns which follow on closely from one another can be performed since at least two turns can be combined into a single event, e.g. as a U-turn. Such an event, such as the U-turn, can be detected if two turns are located within a specific parameterizable route section and the turn angle sum of which exceeds a parameterizable total angle.

The possibly parameterizable target speed can then be determined from the adding together of the turn angles of both intersections or turns. A new event can accordingly be generated from two turns which in the case of conventional methods represent in each case an event, in which methods an intervention is made into the longitudinal guide or the driving dynamics of the motor vehicle irrespective of one another.

The new event generated in this manner can have two destination points to be reached consecutively. From a first of the two destination points which can be located at a possibly parameterizable distance in front of the first turn, the vehicle speed can be reduced so that it is possible to pass through both turns without (driver) intervention in the longitudinal dynamics. The target speed can then be maintained up to a second of the two destination points, which should additionally make it possible for the driver to give way to crossing traffic in a timely manner. The second of the two destination points can be located at the location of the second intersection.

A control device is furthermore provided. The control device is characterized in that it is configured to at least partially execute the method described above.

The control device can be part of a driver assistance system or represent this. The control device can be, for example, an electronic control unit (ECU). The electronic control device can be an intelligent processor-controlled unit which can communicate with other modules via a central gateway (CGW) and can form the vehicle electrical system together with telematic control devices via fieldbuses such as the CAN bus, LIN bus, MOST bus and FlexRay or via automotive ethernet. The electronic control device can control the functions relevant for the driving characteristics of the motor vehicle such as motor control, force transmission, the brake system or the tire pressure control system. All of the driver assistance systems such as, for example, the parking assistant, adaptive cruise control, a lane departure warning system, a lane change assistant, traffic sign recognition, traffic light detection, hill start assistant, attention assistant, intersection assistant and many others can furthermore be controlled by the electronic control device.

It is conceivable that the control device is connected to a longitudinal guidance control unit which enables an automated intervention in the speed of the motor vehicle on the basis of a control signal received by the control device. This longitudinal guidance control unit can also be referred to as cruise control. The longitudinal guidance control unit can have a position regulation unit, i.e. this can be configured to adjust the speed and, where applicable, an acceleration of the motor vehicle at a possible parameterizable location to a target speed value on the basis of the control signal received by the control device. The control device and/or the longitudinal guidance control unit can furthermore be connected to a navigation system which can transmit upcoming map attributes in particular in the form of segments and their properties to the longitudinal guidance control unit or the control device. The control device can be configured to be able to react in an automated manner on the basis of events (e.g. curves, roundabout, turn and/or traffic lights, etc.) from the digital map, i.e. be able to intervene in the longitudinal and/or transverse guidance of the motor vehicle.

The situation described above in relation to the method also applies in an analogous manner to the control device and vice versa.

An automated motor vehicle is furthermore provided. The automated motor vehicle is characterized in that it has the control device described above.

The motor vehicle can be an automobile. The automated motor vehicle is configured to at least partially and/or temporarily take on a longitudinal guidance and, where necessary, a transverse guidance in the case of automated driving of the motor vehicle. Automated driving can be performed so that the continued movement of the motor vehicle is performed (largely) autonomously.

The motor vehicle can be a motor vehicle of autonomy level 1, i.e. have certain driver assistance systems which assist the driver in operating the vehicle, such as, for example, adaptive cruise control (ACC).

The motor vehicle can be a motor vehicle of autonomy level 2, i.e. be partially automated so that functions such as automatic parking, lane-keeping or transverse guidance, general longitudinal guidance, acceleration and/or braking are taken on by driver assistance systems.

The motor vehicle can be a motor vehicle of autonomy level 3, i.e. be conditionally automated so that the driver does not have to continuously monitor the vehicle system. The motor vehicle independently performs functions such as triggering the indicator, lane change and/or lane-keeping. The driver can turn his or her attention to other things, but where necessary is prompted by the system within a prewarning period to take over control.

The motor vehicle can be a motor vehicle of autonomy level 4, i.e. be highly automated so that the control of the vehicle is permanently taken on by the vehicle system. If the system no longer has control of the driving tasks, the driver can be prompted to take over control.

The motor vehicle can be a motor vehicle of autonomy level 5, i.e. be fully automated so that the driver is no longer required to perform the task of driving. No human intervention is necessary apart from specifying the destination and starting the system. The motor vehicle can manage without a steering wheel and pedals.

The situation described above in relation to the method and to the control device also applies in an analogous manner to the motor vehicle and vice versa.

A computer program is furthermore provided. The computer program is characterized in that it comprises commands which, when the program is executed by a computer, cause it to at least partially execute the method described above.

A program code of the computer program can be present in any desired code, in particular in the code which is suitable for control units of motor vehicles.

A computer-readable storage medium is furthermore provided. The computer-readable storage medium is characterized in that it comprises commands which, when the program is executed by a computer, cause it to at least partially execute the method described above.

The means that a computer-readable medium can also be provided which comprises a computer program defined above. The computer-readable medium can be any desired data storage device such as, for example, a USB stick, a hard drive, a CD ROM, an SD card or an SSD card. The computer program does not necessarily have to be stored on such a computer-readable medium in order to be made available to a driver but can also be referred to via the internet or externally in another manner.

The situation described above in relation to the method, to the control device and to the automated motor vehicle also applies in an analogous manner to the computer program and the computer-readable storage medium and vice versa.

An embodiment is described below with reference to FIGS. 1 to 4.

### BRIEF DESCRIPTION OF THE DRAWINGS

FIG. 1 shows schematically a motor vehicle with a control device which is configured to execute a method for automated longitudinal guidance of the motor vehicle,

FIG. 2 shows schematically a flow chart of the method for automated longitudinal guidance of the motor vehicle,

FIG. 3 shows schematically and by way of example an upcoming route section with two bends, and

FIG. 4 shows schematically and by way of example a speed profile of the motor vehicle controlled according to the method from FIG. 2 when passing through the two bends from FIG. 3.

### DETAILED DESCRIPTION OF THE DRAWINGS

An automated motor vehicle 1 is represented in a schematic side view in FIG. 1, wherein the motor vehicle 1 has a control unit 2 which is connected to a navigation system 2 and a speed control apparatus 4 of the motor vehicle.

The control unit 2, the navigation system 3 and the speed control apparatus 4 jointly form a driver assistance system which is configured to execute the method for automated longitudinal guidance of the motor vehicle 1.

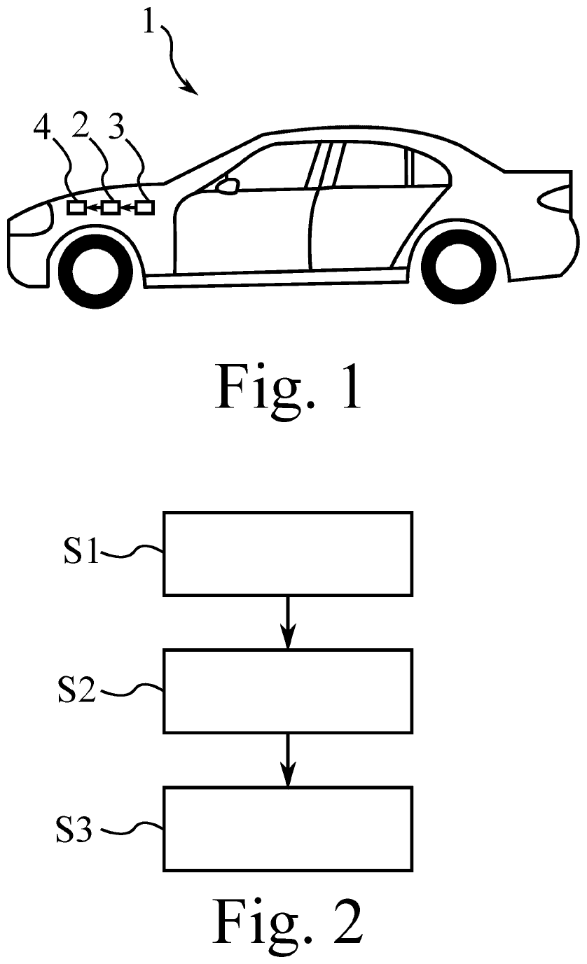

As is apparent from FIG. 2, the method for automated longitudinal guidance of the motor vehicle 1 has substantially three steps S1, S2, S3.

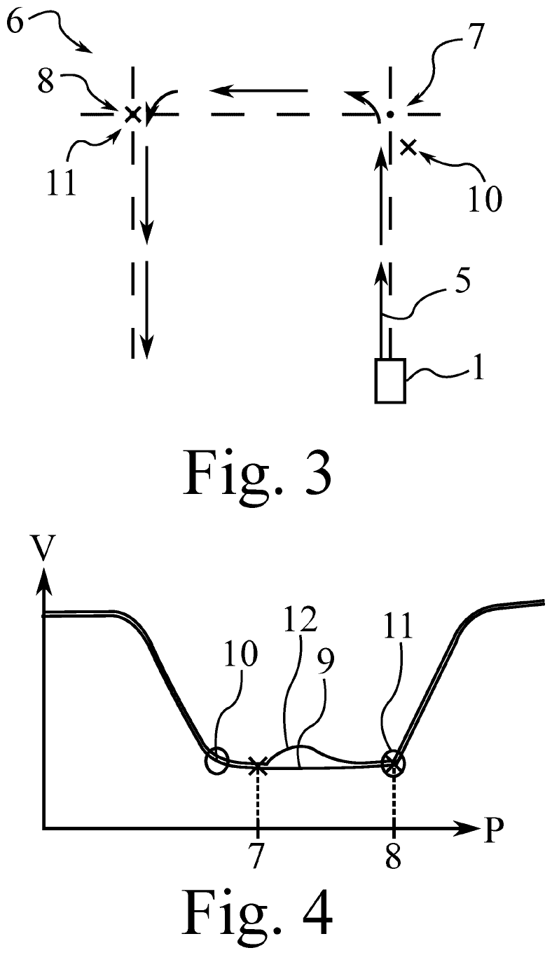

In a first step S1 of the method, the control unit 1 receives map data 6 from the navigation system 3 in relation to an upcoming route section, wherein the map data 6 include a trajectory or planned route 5 of the motor vehicle 1. This trajectory 5 is represented by arrows in the map data 6 in FIG. 3.

In the second step S2 of the method, detection is performed as to whether two bends 7, 8 lie in the upcoming route section. As is apparent in FIG. 3, two consecutive bends 7, 8 are located along the trajectory 5 of the motor vehicle 1 which have in each case a center point angle of 90°.

The detection of the two bends 7, 8, which is performed by the control unit 2 on the basis of the map data 6 and the trajectory 5, comprises an adding up of the angle of the first turn 7 and the angle of the second turn 8 in order to thus obtain a total angle. The total angle is consequently 180° in the present case. This total angle is compared with at least one threshold value, in the present case with several predetermined threshold values stored in a database (not represented). A specific event is assigned to each of the threshold values, such as for example and applicable in this case the event U-turn. The threshold value for U-turn can be, for example, 170°. Since the total angle exceeds the threshold value, it is detected by the control unit 3 that two bends 7, 8 lie in the upcoming route section, which bends 7, 8 are to be assigned to the event U-turn.

In a third step S3 of the method, since it was detected in the second step S2 of the method that the two turns 7, 8 lie in the upcoming route section, the control unit 2 issues a control signal to the speed control apparatus 4.

This control signal causes the speed control apparatus 4 to intervene in the longitudinal dynamics of the motor vehicle 1, to be more precise adapt its speed as a function of a position of the motor vehicle 1, as is represented in detail in FIG. 4.

FIG. 4 represents the target speed value 9, which can also be referred to as a setpoint speed value, as a function of a position P of the motor vehicle 2 relative to the two turns 7, 8. The speed V is therefore plotted on the vertical axis of the diagram from FIG. 4 and the position P is plotted on the horizontal axis.

As is apparent from a combined view of FIGS. 3 and 4, the control signal causes the speed control apparatus 4 to reduce the target speed value 9 until a constant target speed value is reached. The speed control apparatus 4 reduces the target speed value 9 so that the constant target speed value is reached at a first point in time 10 which is still prior to the first turn 7. This means that the speed of the motor vehicle 1 is adjusted to the constant target speed value by means of the speed control apparatus 4 before the motor vehicle 1 reaches the first turn 7. The speed control apparatus 4 subsequently keeps the target speed value 9 constant until a second point in time 11 that lies in the second turn 8 is reached so that the speed of the motor vehicle 1 remains constant even when passing through a first turn 7 until the second turn 8 is reached. This significant difference to known methods in which the target speed value 12 increases between the two turns 7, 8 since the control unit regards each of the turns 7, 8 conventionally as an independent event. These interim acceleration and braking processes are consequently prevented according to the present method. The constant target speed value is selected as a function of the total angle described above of the two turns 7, 8 by the control device. When the second point in time 11 is reached, the target speed value 9 is increased by the speed control apparatus 4 so that the motor vehicle 1 accelerates. An adjustment of the speed of the motor vehicle 1 to a target speed value which exceeds the constant target speed value is accordingly performed when (or possibly also after, but not represented here) passing through the second turn 11.

### LIST OF REFERENCE SIGNS

1 Motor vehicle
2 Control device
3 Navigation system
4 Speed control apparatus
5 Trajectory
6 Map data
7 First turn
8 Second turn
9 Target speed value
10 First destination point
11 Second destination point
12 Conventional target speed value
P Position
S1-S3 Steps of the method
V Speed

1-10. (canceled)

11. A method for the automated longitudinal guidance of a motor vehicle, the method comprising:
detecting whether two turns lie in an upcoming route section; and
in response to detecting that two turns lie in the upcoming route section, maintaining a speed of the motor vehicle at a constant target speed value after passing through a first of the two turns until a second of the two turns is reached.

12. The method of claim 11, wherein detecting whether two turns lie in the upcoming route section comprises:
adding up an angle of the first turn and an angle of the second turn to obtain a total angle;
comparing the total angle with a threshold value; and
detecting that two turns lie in the upcoming route section when the total angle exceeds the threshold value.

13. The method of claim 12, wherein the constant target speed value is selected as a function of the total angle.

14. The method of claim 11, further comprising:
in response to detecting that two turns lie in the upcoming route section, adjusting the speed of the motor vehicle to the constant target speed value before the motor vehicle reaches the first turn.

15. The method of claims 11, further comprising:
in response to detecting that two turns lie in the upcoming route section, adjusting the speed of the motor vehicle to a target speed value which exceeds the constant target speed value during or after passing through the second turn.

16. The method of claim 11, wherein detecting whether two turns lie in an upcoming route section is performed on the basis of map data and a planned trajectory of the motor vehicle.

17. A control device configured to execute the method of claim 11.

18. An automated motor vehicle, comprising the control device of claim 17.

19. A computer program stored on a non-transitory medium and executable by a computer so as to cause the processor to perform the method of claim 11.

20. A non-transitory computer-readable storage medium storing computer-readable commands that, when executed by a computer, cause the computer to perform the method of claim 11.
